(19) United States
(12) Patent Application Publication
(10) Pub. No.: US 2008/0209651 A1
(43) Pub. Date: Sep. 4, 2008

(54) Wiper Plate

(75) Inventors: Ismo Reponen, Naantali (FI); Keijo Lindholm, Salo (FI); Ulla Tannijarvi, Salo (FI)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Carl Freudenberg KG, Weinheim (DE)

(21) Appl. No.: 11/908,370

(22) PCT Filed: Feb. 3, 2006
(86) PCT No.: PCT/EP06/00930

§ 371 Date: Sep. 11, 2007

(30) Foreign Application Priority Data
Mar. 16, 2005 (DE) 10 2005 012 491.7

(51) Int. Cl. B25G 1/00

(52) U.S. Cl. 15/143.1

(57) ABSTRACT

The invention relates to a wiper plate (1) for a cleaning device (20), which can be connected to a handle (3) by means of a joint (2). Said joint (2) comprises a first bore (9) and a joint pin (4) which can be pivotably mounted on the wiper plate (1) which comprises a recess (5). Additional bores (7, 8) are arranged in the recess (5), which are oriented in a coaxial manner in relation to the first bore (9) and the joint pin (4) is arranged in the bores (7, 8, 9).

### TECHNICAL FIELD

The invention relates to a wiper plate for a cleaning device, which wiper plate is connected by a joint to a handle, where the joint presents a first bore and is attached pivotably to a joint pin arranged on the wiper plate, where the wiper plate presents a recess.

### STATE OF THE ART

Such wiper plates are known from EP 1 039 829 B1. In the already-known wiper plate, the joint pin is arranged in a recess, where the recess is provided in a shoulder that is raised on a main side of the wiper plate. The result is a high wiper plate in which only one main side can be used as a wiping surface. The movement latitude of the joint arranged on the joint pin is limited. The joint pin is configured to be made of one piece and of the same material as the wiper plate, and the joint attachment is carried out by means of a snap-on connection.

### PRESENTATION OF THE INVENTION

The invention is based on the problem of providing a wiper plate with a robust joint attachment that does not become detached.

The problem is solved by the characteristics of Claims 1 and 12. The dependent claims refer to advantageous embodiments.

To solve the problem, additional bores are arranged in the recess and are coaxial to the first bore in orientation, and the joint pin is arranged in the bores. The joint pin is here a separate element and it can be formed from a stable material, for example, from a metal material. Because the joint completely encloses the joint pin through the bore, the joint is connected to the wiper plate in such a way that it cannot become detached, and the joint, even during robust use, such as, for example, in the professional sector, cannot become independently detached. In addition, as a result of the complete enclosure of the joint pin by the material of the wiper plate, the pin incorporation can present maximum rigidity with a minimal wiper plate thickness. The wiper plate can be designed to be flat, because of the recess in which the bores are arranged. For reasons pertaining to improved rigidity, and to simplify the manufacture, it is advantageous for the wiper plate to be designed as a single piece and of the same material. Moreover, the diameters of the bores can be chosen in such a way that the joint pin sits in the bore of the joint with some play, and in the bores of the wiper plate with press fit. As a result, the joint is easily movable and it can be connected by press fit to the wiper plate in a manner that prevents its detachment.

The joint pin can be of a rigid design. Such joint pins are cost effective and, in comparison to spring-loaded pins, particularly stable.

The wiper plate can present two main sides that are designed as wiping surfaces, and the joint pin can be arranged at least partially between the two main sides. As a result of the arrangement of the joint pin below the wiping surfaces, interfering attachments or shoulders can be omitted, and the wiping surfaces can be configured to be flat.

The joint pin can be arranged substantially in the middle, with respect to the plate height of the wiper plate. As a result, the joint pin is located in the area of the center of gravity, and the pivoting axis of the joint pin is in the area of the central plane of the wiper plate, which simplifies the maneuvering of the wiper plate. Moreover, with such an arrangement, the wiper plate can have a particularly thin design.

Adjacent to the recess, a perforation can be provided, which is connected to the recess by a bore of the wiper plate. As a result, the mounting of the wiper plate is simplified because the joint pin in the perforation can be moved into a position parallel to the bores. The diameters of the bores can be adapted to the joint pin, and thus tilting of the joint point during mounting is prevented.

A connection body can be arranged in the perforation. The connection body is designed in such a way that the result is a flat surface of the main sides configured as wiping surfaces. The closure body prevents an autonomous detachment of the attachment pin, and as a result a press fit of the joint pin in the bores of the wiper plate is not necessary. Thus, the joint pin can be designed to be shiftable, and the mounting of the wiper plate is simplified. Moreover, the closure body prevents the penetration of dirt.

The closure body can be detachable, and attachable with positive connection in the perforation. This allows a nondestructive removal of the joint pin, for example, to be able to replace individual components of the wiper plate. In other embodiments, the closure body can also be glued in.

The closure body can present, on at least two mutually facing sides, a dovetail-shaped profile, which can be engaged in a counter profile with congruent design of the perforation. The dovetail-shaped profile and the counter profile can be manufactured in a simple way, and the closure body can be mounted in a simple way and with little force exertion, resulting in a reliable positive and frictional connection.

The closure body can be formed from an elastomer material. Due to the elastomer material, the closure body is reversibly deformable, which results additionally in a reduction of the force exerted during the mounting. In other embodiments, the closure body can be designed in several parts. For this purpose, a more cost effective material can be used. The mounting can be carried out with a glue or snap-on connection.

The recess can be open towards one side of the wiper plate. Here, the result is a large pivot radius for the joint of more than 180° because the joint can be pivoted entirely through the open recess. This is particularly advantageous if both main sides of the wiper plate are configured as wiping surfaces, and if the main sides are to be moved alternately in the direction towards the floor to be cleaned.

The wiper plate can be pivotable with respect to the joint in such a way that both main sides of the wiper plates can be pivoted in the direction towards the floor to be cleaned. As a result, both main sides of the wiper plate can be designed as a wiping surface, and the performance in terms of surface area covered by the cleaning device is increased.

The problem is solved by a method for mounting a wiper plate, where the joint is positioned in the recess, so that bores of the wiper plate and of the joint overlap, the joint pin is positioned in the perforation and inserted into the bores, and the perforation is closed by the closure body. Because the recess in which the joint pin is arranged is open on one side, the joint has a large pivot radius. Here, the resulting pivot radius is greater than 180° because the joint can be pivoted completely through the open recess. This is particularly advantageous if both main sides of the wiper plate is [sic; are] configured as a wiping surface, and the main sides are to be moved alternately in the direction towards the floor to be cleaned. The joint pin can be moved in the perforation in a position parallel to the bores. The diameters of the bores can here be adjusted to the joint pin, and tilting of the joint pin during mounting is prevented. The closure body prevents the joint pin from independent detachment.

### BRIEF DESCRIPTION OF THE DRAWINGS

Several embodiment examples of the wiper plate according to the invention are explained in greater detail with reference to the figures. Shown schematically are:

FIG. 1 an exploded view of the wiper plate; and

FIG. 2 a perspective view of the wiper plate.

### EXPLANATION OF THE INVENTION

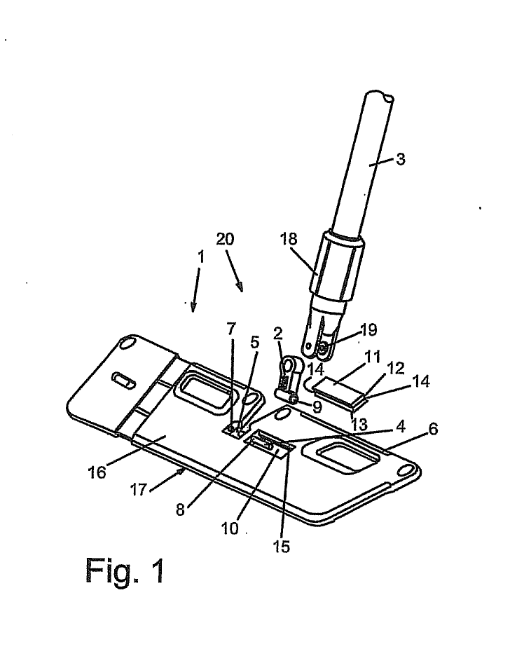

FIG. 1 shows a wiper plate 1 for a cleaning device 20, which is connected via a joint 2 with a clamp screw connection 18 to a handle 3. The clamp screw connection 18 is connected to the joint 2 by a rivet connection 19, which forms simultaneously the second joint axis of the joint 2 configured as a universal joint. The wiper plate 1 presents a recess 5, which is open towards one side 6 of the wiper plate 1, and which is configured in section in the shape of a V, to increase the pivot radius of the joint 2. The bores 7, 8 are arranged in the recess 5. The joint 2 presents an additional bore 9, where the bores 7, 8, 9 are coaxial with respect to each other. In the bores 7, 8, 9, a joint pin 4 is arranged by means of which the joint 2 can be pivoted relative to the wiper plate 1. The joint pin 4 is configured to be rigid and, below the main sides 16, 17, in this embodiment arranged in the middle with respect to the plate height of the wiper plate 1. Adjacent to the recess 5, a perforation 10 is arranged, through which the bore 8 is connected to the recess 5. In the perforation 10, a closure body 11 is arranged, which, after the mounting, prevents the joint pin 4 from becoming independently detached. The closure body 11 presents on two opposite sides 12, 13, in this embodiment the length-wise sides, a dovetail-shaped profile 14, which engages in a counter profile 15 of congruent design of the perforation 10. The closure body 11 is made of an elastomer material, in this embodiment rubber, and as a result it is attached by a simple detachable and positive connection in the perforation 10. The wiper plate 1 can be pivoted relative to the joint 2 in such a way that both main sides 16, 17 of the wiper plate 1 can be pivoted in the direction of the floor to be cleaned. Here the two main sides 16, 17 are designed as a wiping surface.

To mount the wiper plate 1, the joint 2 is positioned in the recess 4 so that the bores 7, 8, 9 of the wiper plate 1 and of the joint 2 are congruent. The joint pin 4 is then positioned in the perforation 10, and inserted into the bores 7, 8, 9. Subsequently, the perforation 10 is closed by the closure body 11.

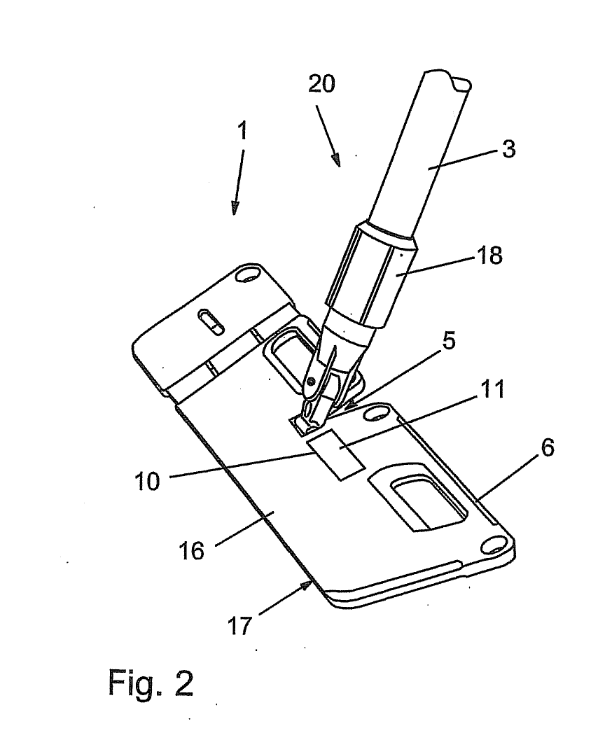

FIG. 2 shows the mounted wiper plate 1 according to FIG. 1 in a perspective view.

1. Wiper plate for a cleaning device, comprising a wiper plate which is connectable to a handle by a joint, where the joint presents a first bore and is attached pivotably to a joint pin arranged on the wiper plate, where the wiper plate presents a recess, in the recess, additional bores are arranged, which are oriented coaxially with respect to the first bore, and in that the joint pin is arranged in the bores.

2. Wiper plate according to claim 1, wherein the joint pin is configured to be rigid.

3. Wiper plate according to claim 1, wherein the wiper plate presents two main sides, which are configured as wiping surfaces, and in that the joint pin is arranged at least partially between the main sides.

4. Wiper plate according to claim 1, wherein the joint pin is arranged substantially in the middle, with respect to the plate height of the wiper plate.

5. Wiper plate according to claim 1, wherein adjacent to the recess, a perforation is arranged, which is connected to the recess by a bore of the wiper plate.

6. Wiper plate according to claim 5, wherein a closure body is arranged in the perforation.

7. Wiper plate according to claim 6, wherein the closure body is attachable by a detachable and positive connection in the perforation.

8. Wiper plate according to claim 6 wherein the closure body, on at least two mutually opposite sides, presents a dovetail-shaped profile, which can engage in a counter profile with congruent design of the perforation.

9. Wiper plate according to claim 6, wherein the closure body is formed from an elastomer material.

10. Wiper plate according to claim 1, wherein the recess is open towards a side of the wiper plate.

11. Wiper plate according to claim 3, wherein the wiper plate is pivotable with respect to the joint so that both main sides of the wiper plate are pivotable in the direction towards the floor to be cleaned.

12. Method for mounting a wiper plate, the wiper plate is connectable to a handle by a joint, where the joint presents a first bore and is attached pivotably to a joint pin, where the wiper plate presents a recess, in the recess, additional bores are arranged, which are oriented coaxially with respect to the first bore, adjacent to the recess, a perforation is arranged, which is connected to the recess by a bore of the wiper plate, a closure body is arranged in the perforation, comprising the joint is positioned in the recess, so that the bores of the wiper plate and of the joint are congruent, the joint pin is positioned in the perforation and inserted into the bores, and the perforation is closed by the closure body.
